(19) United States
(12) Patent Application Publication
(10) Pub. No.: US 2015/0177778 A1
(43) Pub. Date: Jun. 25, 2015

(54) ADHESIVE FILM FOR ADHERING TO SUBSTRATE

(71) Applicant: HENGHAO TECHNOLOGY CO., LTD., Hsinchu County (TW)

(72) Inventors: CHIN-LIANG CHEN, Kaohsiung City (TW); MING-CHIH CHEN, Changhua County (TW)

(21) Appl. No.: 14/299,849

(22) Filed: Jun. 9, 2014

(30) Foreign Application Priority Data
Dec. 25, 2013 (TW) 102148299

(51) Int. Cl. G06F 1/16; G06F 3/041

(52) U.S. Cl. CPC G06F 1/16; G06F 3/041

(57) ABSTRACT

An adhesive piece for adhering to a substrate is disclosed, wherein the adhesive piece has a film, an opening and a separating structure. The opening is formed on the film and configured to enable the substrate to be connected to a flexible printed circuit. The separating structure is formed on the film and has a plurality of perforated cuts, wherein the plurality of perforated cuts form the perforated line which is configured to be extended from an edge of the opening to an edge of the film.

### CROSS REFERENCE TO RELATED APPLICATION

The present invention claims the benefits of priority from the Taiwan Patent Application No. 102148299, filed on Dec. 25, 2013, the contents of the specification of which are hereby incorporated herein by reference.

### FIELD OF THE INVENTION

The present invention relates to an adhesive piece. In particular, it relates to an adhesive piece for adhering to a semiconductor substrate.

### BACKGROUND OF THE INVENTION

There are many circuits on a semiconductor device, for example, the substrate of a touch panel is generally full of complicated circuit patterns. Such circuits are configured to be coupled to other components with wires, so room for configuring the wires must be reserved on the adhesive pieces which are applied to the semiconductor devices. However, for the convenience of re-adhering the adhesive pieces, the adhesive pieces usually cannot cover the entire semiconductor device because this would cause failure or damage to the semiconductor device as a result of a puncture of the electrostatic force during an Electrostatic Discharge (ESD) test of the semiconductor device, to the semiconductor device.

If the protection against the electrostatic force is enhanced by covering the entire semiconductor device, it will cause the wires to detach or have connection failures because the wires will be pulled during re-adherence. Furthermore, the efficiency of re-adherence may dramatically decrease because additional tools are needed during re-adherence. Hence, the design of traditional adhesive pieces cannot have both convenience and protection at the same time.

It is therefore the Applicant's attempt to deal with the above limitations of the prior art.

### SUMMARY OF THE INVENTION

In accordance with the first aspect of the present invention, an adhesive piece for adhering to a semiconductor substrate is disclosed. The adhesive piece includes: a film having an opening configured to enable the semiconductor substrate to be connected to an external component; and a separating structure formed on the film and having a plurality of perforated cuts, wherein the plurality of perforated cuts form a perforated line configured to be extended from an edge of the opening to an edge of the film.

In accordance with the second aspect of the present invention, a touch panel is disclosed. The touch panel includes: a substrate; an adhesive piece having a film adhered to the substrate; and a separating structure formed on the film and having a plurality of perforated cuts, wherein the plurality of perforated cuts form at least a perforated line configured to be extended from a body point of the film to an edge of the film.

In accordance with the third aspect of the present invention, a removable adhesive piece for adhering to a semiconductor component is disclosed. The removable adhesive piece includes: a body having an opening; and a separating structure formed on the body and having a predefined perforated line extending between the opening and at least an edge of the body to enable a user to partially split the body from the edge along the predefined perforated line.

### BRIEF DESCRIPTION OF THE DRAWINGS

A more complete understanding of the invention and many of the attendant advantages thereof may be readily obtained by reference to the following detailed description when considered in connection with the accompanying drawings, wherein:

FIG. 1 is a schematic diagram of adhering an adhesive piece to a semiconductor substrate according to an embodiment of the present invention;

FIG. 2 is a top view diagram of the adhesive piece according to an embodiment of the present invention;

FIGS. 3-5 are top view diagrams of the adhesive piece with different separating structures according to an embodiment of the present invention;

FIGS. 6-7 are schematic diagrams of tearing the adhesive piece according to an embodiment of the present invention; and

FIG. 8 is a schematic diagram of another adhesive piece according to an embodiment of the present invention.

### DETAILED DESCRIPTION OF THE PREFERRED EMBODIMENTS

The present disclosure will be described with respect to particular embodiments and with reference to certain drawings, but the disclosure is not limited thereto and is limited only by the claims. The drawings described are only schematic and are non-limiting. In the drawings, the size of some of the elements may be exaggerated and not drawn to scale for illustrative purposes. The dimensions and the relative dimensions do not necessarily correspond to actual reductions in practice.

The term “preferably” or “preferred” herein is a non-exclusive term, which should be appreciated as “is/are preferred but not limited to”. Any one of the steps described or disclosed in either the specification or claims can be implemented in any sequence and is not limited to the sequence disclosed in the appended claims. The scope of the invention should only be determined by the appended claims and the equivalents thereof, and should not be determined by the embodiments implemented in this Detailed Description.

It is to be noted that the terms “including”, “include(s)”, “comprising” and “comprise(s)”, used in the claims and the specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

This disclosure will now be described with a detailed description of several embodiments. It is clear that other embodiments can be configured according to the knowledge of persons skilled in the art without departing from the true technical teaching in the present disclosure, the claimed disclosure being only limited by the terms of the appended claims.

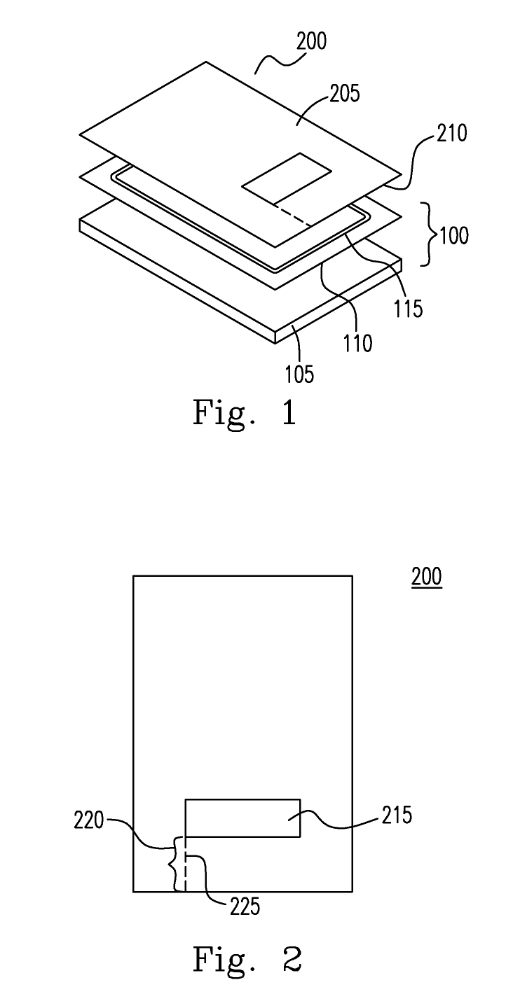

Please refer to FIG. 1, which is a schematic diagram of adhering an adhesive piece to a semiconductor substrate according to an embodiment of the present invention. In FIG. 1, a semiconductor substrate 100 includes a glass substrate 105, a transparent conductive film 110 and a circuit pattern 115. An adhesive piece 200 includes a first surface 205 and a second surface 210, wherein the adhesive piece 200 is used for adhering to the semiconductor substrate 100. Preferably, the first surface 205 of the adhesive piece 200 is a non-adhesive surface and the second surface 210 thereof is an adhesive surface, wherein the glue material on the adhesive surface has re-adherable characteristics. That is, the adhesive piece 200 can be optionally removable after being adhered to the semiconductor substrate 100.

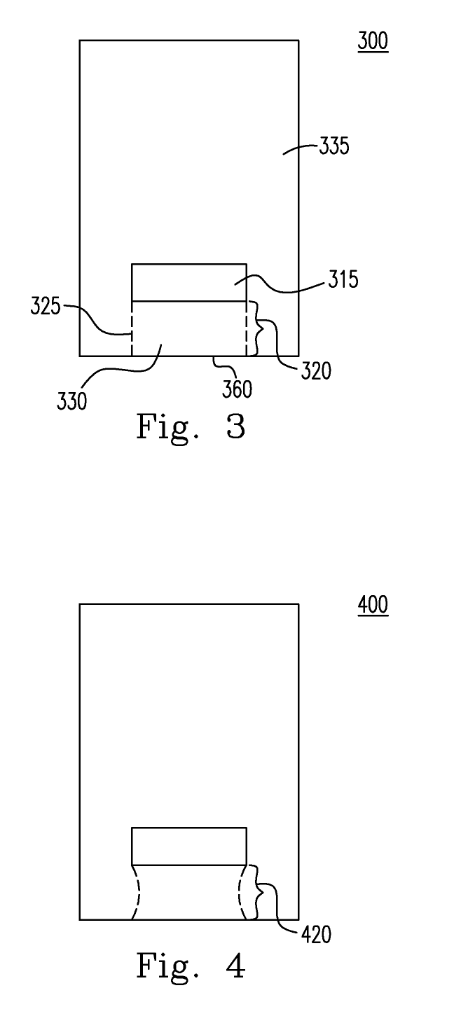

Please refer to FIG. 2, which is a top view diagram of the adhesive piece according to the embodiment of the present invention. In FIG. 2, the adhesive piece 200 includes an opening 215 and a perforated line 220, wherein the perforated line 220 includes a plurality of perforated cuts 225. The opening 215 is configured to enable the circuit pattern 115 on the semiconductor substrate 100 to be connected to an external component, for example, a Flexible Printed Circuit (FPC), a Printed Circuit Board (PCB), an aluminum substrate and a copper substrate, after the adhesive piece 200 is adhered to the semiconductor substrate 100. Preferably, the adhesive piece 200 is a film with a material selected from an anti-scratch material, an anti-reflection material, an anti-glare material and a combination thereof. Preferably, the shape of the opening 215 is selected from a rectangle, a circle, an ellipse and a multi-angle (polygon). Preferably, the opening 215 can be formed on any position of the adhesive piece 200, for example, a position near the edge of the adhesive piece 200 or the center of the adhesive piece 200. Preferably, the adhesive piece 200 can be configured to have a plurality of openings 215. Preferably, each of the first surface 205 and the second surface 210 of the adhesive piece 200 have perforated openings because of the formation of the perforated cuts 225. That is, the perforated cuts 225 are configured to enable the adhesive piece 200 to be penetrated through. Preferably, the first surface of the adhesive piece 200 has perforated openings, which do not penetrate through the second surface 210, because of the formation of the perforated cuts 225. That is, the perforated cuts 225 are trenches formed on the first surface of the adhesive piece 200 without penetrating through the second surface of the adhesive piece 200.

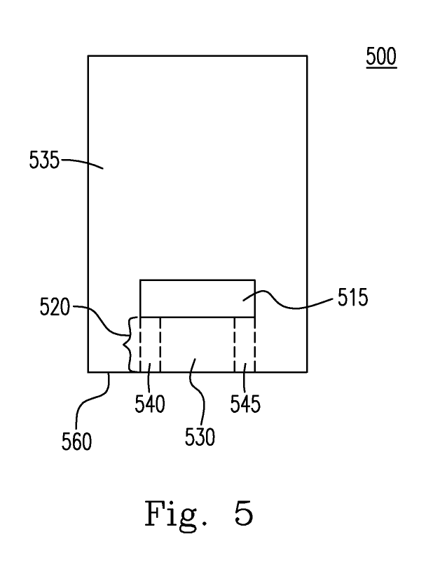

Please refer to FIGS. 3-5, which are top view diagrams of the adhesive piece with different separating structures according to an embodiment of the present invention. In FIG. 3, an adhesive piece 300 includes an opening 315 and two perforated lines 320, wherein each of the perforated lines 320 has a plurality of perforated cuts and these two perforated lines 320 divide the adhesive piece 300 into a first block area 330 and a second block area 335. When the adhesive piece 300 is required to be removed due to a misalignment between the adhesive piece 300 and the semiconductor substrate after the adhesive piece 300 is adhered to the semiconductor substrate, the operator only needs to tear parts of the block areas. For example, the operator can optionally tear the second block area 335 and retain the first block area 330. Accordingly, the efficiency of re-adherence and the yield of the products (e.g. semiconductor substrate, touch panel, semiconductor component, etc.) are highly enhanced. In FIG. 4, an adhesive piece 400 has two curved perforated lines 420.

In FIG. 5, an adhesive piece 500 includes four perforated lines 520, and the adhesive piece 500 is divided into a first block area 530, a second block area 535, a third block area 540 and a forth block area 545 by the four perforated lines 520, wherein the areas of the third block area 540 and the forth block area 545 are equal to and smaller than that of the first block area 530. The difference between the adhesive piece 500 shown in FIG. 5 and the adhesive piece 300 shown in FIG. 3 is that, in the adhesive piece 300, there is the first block area 330 between the longitudinal length of the opening 315 and the edge 360, whereas in the adhesive piece 500, there are the first block area 530, the third block area 540 and the forth block area 545 between the longitudinal length of the opening 515 and the edge 560 (i.e. the third block area 540 and the forth block area 545 are added to the adhesive piece 500). When a misaligned block area (for example, the second block area 535) needs to be removed based on the reason in the above embodiment, the operator can tear the second block area 535, the third block area 540 and the forth block area 545 and retain the first block area 530, and then adhere the second block area 535 again. That is, the third block area 540 and the forth block area 545 are designated as reserve areas for re-adherence. The advantage is that the re-adhered second block area 535 will not overlap the retained first block area 530 during re-adherence. Accordingly, the surface of the adhesive piece 500 will not have a bumpy or uneven area which may result from an overlapped block area, and it benefits other materials and thin films subsequently adhered on the adhesive piece. Preferably, the width of the opening is 5 mm and the length is 10 mm.

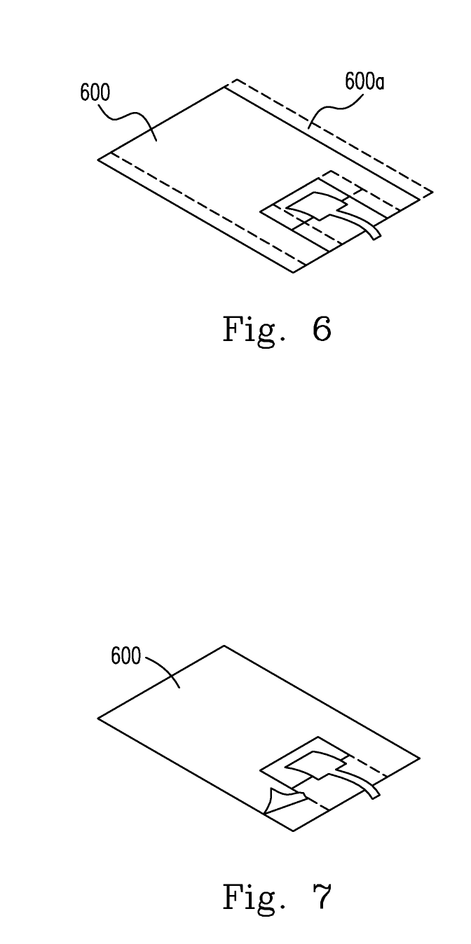

Please refer to FIGS. 6-7, which are schematic diagrams of tearing the adhesive piece according to an embodiment of the present invention. As shown in FIG. 6, the adhesive piece 600 should be adhered to the predetermined position, i.e. area 600a. Because of a misalignment during adherence, the adhesive piece 600 must be removed. As shown in FIG. 7, because of the configuration of the perforated line, the operator can easily tear off the adhesive piece 600 along the perforated line.

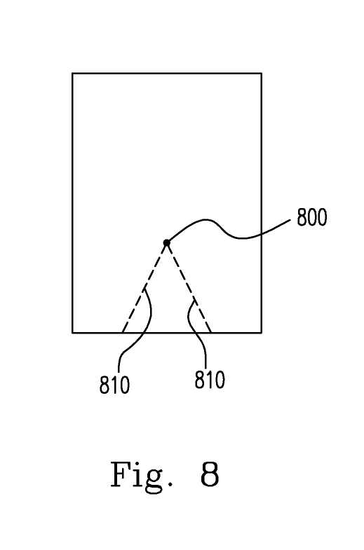

Please refer to FIG. 8, which is a schematic diagram of another adhesive piece according to an embodiment of the present invention. In FIG. 8, the perforated lines 810 are configured to be extended from a body point 800 to the edge of the film.

In certain embodiments, the perforated lines on the adhesive piece can be formed by a method selected from a laser technique, a wire cutting technique and a die cutting technique.

The advantages of the present invention are described as follows. Because the perforated line has perforated cuts, the adhesive piece is split along the perforated line when it is torn off, without pulling on a connected external component such as FPC. Accordingly, the replacement of the adhesive piece will not disturb the connection stability between the external component and the semiconductor substrate. Also, the problems such as the detachment and the poor signal quality of the external component are thereby eliminated. Alternatively, by means of the design of the present invention, the adhesive piece can be manually removed without other tools such as scissors and cutters. In other words, the present invention can highly enhance the efficiency and dramatically improve the yield during re-adherence so as to ensure the smoothness of the surface of the adhesive piece.

Another advantage of the present invention is described below. Because of the design of the present invention, the adhesive piece covers the majority of the surface of the substrate after the re-adherence so that the product will not be damaged by the puncture of the electrostatic force during an Electrostatic Discharge (ESD) test of the product. That is to say, the design of the present invention prevents the external component from being pulled and the substrate from being punctured, and enables the adhesive piece to have the characteristics of efficient re-adherence and high protection ability.

There are further embodiments provided as follows.

### Embodiment 1

An adhesive piece for adhering to a semiconductor substrate including: a film having an opening configured to enable the semiconductor substrate to be connected to an external component; and a separating structure formed on the film and having a plurality of perforated cuts, wherein the plurality of perforated cuts form a perforated line configured to be extended from an edge of the opening to an edge of the film.

### Embodiment 2

The adhesive piece according to Embodiment 1, wherein the separating structure further comprises a plurality of perforated lines dividing the film into a plurality of block areas, wherein every two adjacent block areas have two adjacent portions divided by a perforated line having a plurality of non-perforated areas, each of which is defined by the two adjacent perforated cuts.

### Embodiment 3

The adhesive piece according to Embodiment 1 or 2, wherein the separating structure further comprises a plurality of perforated lines separating the film into a plurality of block areas.

### Embodiment 4

The adhesive piece according to any one of Embodiments 2-3, wherein the external component is one selected from a group consisting of a Flexible Printed Circuit, a Printed Circuit Board, an aluminum substrate and a copper substrate.

### Embodiment 5

The adhesive piece according to any one of Embodiments 2-4, wherein the opening has a shape being one selected from a group consisting of a rectangle, a circle, an ellipse and a multi-angle.

### Embodiment 6

The adhesive piece according to any one of Embodiments 2-5, wherein the film has a material being one selected from a group consisting of an anti-scratch material, an anti-reflective material and an anti-glare material.

### Embodiment 7

The adhesive piece according to any one of Embodiments 2-6, wherein the film is removable after being adhered.

### Embodiment 8

The adhesive piece according to any one of Embodiments 2-7, wherein the perforated line is one selected from a group consisting of a straight line, a curved line and a zigzag line.

### Embodiment 9

A touch panel including: a substrate; an adhesive piece having a film adhered to the substrate; and a separating structure formed on the film and having a plurality of perforated cuts, wherein the plurality of perforated cuts form at least a perforated line configured to be extended from a body point of the film to an edge of the film.

### Embodiment 10

The touch panel according to Embodiment 9, wherein the film has an opening configured to enable the substrate to be connected to an external component and the opening has a corner being the body point.

### Embodiment 11

The touch panel according to Embodiment 9 or 10, wherein the external component is one selected from a group consisting of a Flexible Printed Circuit, a Printed Circuit Board, an aluminum substrate and a copper substrate.

### Embodiment 12

The touch panel according to any one of Embodiments 9-11, wherein the separating structure further comprises a plurality of perforated lines dividing the film into a plurality of block areas, wherein every two adjacent block areas have two adjacent portions divided by a perforated line having a plurality of non-perforated areas, each of which is defined by the two adjacent perforated cuts.

### Embodiment 13

The touch panel according to any one of Embodiments 9-12, wherein the separating structure further comprises a plurality of perforated lines separating the film into a plurality of block areas.

### Embodiment 14

The touch panel according to any one of Embodiments 9-13, wherein the film is removable after being adhered.

### Embodiment 15

A removable adhesive piece for adhering to a semiconductor component including: a body having an opening; and a separating structure formed on the body and having a predefined perforated line extending between the opening and at least an edge of the body to enable a user to partially split the body from the edge along the predefined perforated line.

### Embodiment 16

The removable adhesive piece according to Embodiment 15, wherein the separating structure further comprises a plurality of perforated lines dividing the body into a plurality of block areas, wherein every two adjacent block areas have two adjacent portions divided by a perforated line having a plurality of non-perforated areas, each of which is defined by the two adjacent perforated cuts.

### Embodiment 17

The removable adhesive piece according to Embodiment 15 or 16, wherein the separating structure further comprises a plurality of perforated lines separating the body into a plurality of block areas.

### Embodiment 18

The removable adhesive piece according to any one of Embodiments 15-17, wherein each of the plurality of predefined perforated lines is one selected from a group consisting of a straight line, a curved line and a zigzag line.

### Embodiment 19

The removable adhesive piece according to any one of Embodiments 15-18, wherein the opening has a shape being one selected from a group consisting of a rectangle, a circle, an ellipse and a multi-angle.

### Embodiment 20

The removable adhesive piece according to any one of Embodiments 15-19, wherein the opening is configured to enable the semiconductor component to be connected to an external component.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustrations should not be taken as limiting the scope of the present disclosure, which is defined by the appended claims.

What is claimed is:

1. An adhesive piece for adhering to a semiconductor substrate, comprising:
a film having an opening configured to enable the semiconductor substrate to be connected to an external component; and
a separating structure formed on the film and having a plurality of perforated cuts, wherein the plurality of perforated cuts form a perforated line configured to be extended from an edge of the opening to an edge of the film.

2. The adhesive piece according to claim 1, wherein the separating structure further comprises a plurality of perforated lines dividing the film into a plurality of block areas, wherein every two adjacent block areas have two adjacent portions divided by a respective perforated line having a plurality of non-perforated areas, each of which is defined by the respective two adjacent perforated cuts.

3. The adhesive piece according to claim 1, wherein the separating structure further comprises a plurality of perforated lines separating the film into a plurality of block areas.

4. The adhesive piece according to claim 1, wherein the external component is one selected from a group consisting of a Flexible Printed Circuit, a Printed Circuit Board, an aluminum substrate and a copper substrate.

5. The adhesive piece according to claim 1, wherein the opening has a shape being one selected from a group consisting of a rectangle, a circle, an ellipse and a multi-angle.

6. The adhesive piece according to claim 1, wherein the film has a material being one selected from a group consisting of an anti-scratch material, an anti-reflective material and an anti-glare material.

7. The adhesive piece according to claim 1, wherein the film is removable after being adhered.

8. The adhesive piece according to claim 1, wherein the perforated line is one selected from a group consisting of a straight line, a curved line and a zigzag line.

9. A touch panel, comprising:
a substrate;
an adhesive piece having a film adhered to the substrate; and
a separating structure formed on the film and having a plurality of perforated cuts, wherein the plurality of perforated cuts form at least a perforated line configured to be extended from a body point of the film to an edge of the film.

10. The touch panel according to claim 9, wherein the film has an opening configured to enable the substrate to be connected to an external component and the opening has a corner being the body point.

11. The touch panel according to claim 10, wherein the external component is one selected from a group consisting of a Flexible Printed Circuit, a Printed Circuit Board, an aluminum substrate and a copper substrate.

12. The touch panel according to claim 9, wherein the separating structure further comprises a plurality of perforated lines dividing the film into a plurality of block areas, wherein every two adjacent block areas have two adjacent portions divided by a respective perforated line having a plurality of non-perforated areas, each of which is defined by the respective two adjacent perforated cuts.

13. The touch panel according to claim 9, wherein the separating structure further comprises a plurality of perforated lines separating the film into a plurality of block areas.

14. The touch panel according to claim 9, wherein the film is removable after being adhered.

15. A removable adhesive piece for adhering to a semiconductor component, comprising:
a body having an opening; and
a separating structure formed on the body and having a predefined perforated line extending between the opening and at least an edge of the body to enable a user to partially split the body from the edge along the predefined perforated line.

16. The removable adhesive piece according to claim 15, wherein the separating structure further comprises a plurality of perforated lines dividing the body into a plurality of block areas, wherein every two adjacent block areas have two adjacent portions divided by a respective perforated line having a plurality of non-perforated areas, each of which is defined by the respective two adjacent perforated cuts.

17. The removable adhesive piece according to claim 15, wherein the separating structure further comprises a plurality of perforated lines separating the body into a plurality of block areas.

18. The removable adhesive piece according to claim 15, wherein each of the plurality of predefined perforated lines is one selected from a group consisting of a straight line, a curved line and a zigzag line.

19. The removable adhesive piece according to claim 15, wherein the opening has a shape being one selected from a group consisting of a rectangle, a circle, an ellipse and a multi-angle.

20. The removable adhesive piece according to claim 15, wherein the opening is configured to enable the semiconductor component to be connected to an external component.
